(19) United States
(12) Patent Application Publication
(10) Pub. No.: US 2011/0185179 A1
(43) Pub. Date: Jul. 28, 2011

(54) System And Method For Digital Rights Management With A Lightweight Digital Watermarking Component

(76) Inventors: Viswanathan Swaminathan, Fremont, CA (US); Sunil C. Agrawal, Milpitas, CA (US)

(21) Appl. No.: 12/548,228

(22) Filed: Aug. 26, 2009

(51) Int. Cl. H04L 9/32; H04N 7/167

(52) U.S. Cl. 713/176; 380/210

(57) ABSTRACT

Various embodiments of a system and method for digital rights management with a lightweight digital watermarking component are described. Embodiments may include methods as well as elements for performing such methods. Such a method may include receiving content onto a computer system; the computer system may include a runtime component configured to consume the content. The method may include receiving a digital watermarking component on the computer system. The digital watermarking component may specify information for generating a digital watermark on the content. The method may include applying a digital watermark to the content with the runtime component in order to generate watermarked content. The digital watermark may be applied by the runtime component in accordance with the digital watermarking component. In various embodiments, the received runtime component may be configured to prevent the received content from being consumed without the digital watermark applied to the received content.

### BACKGROUND

1. Field of the Invention

The present invention is directed to computer systems. More particularly, it is directed to digital rights management within a computing environment.

2. Description of the Related Art

In prior years it would not be uncommon for an individual to obtain content (e.g., literary works, periodicals, music, and movies) from a retail location in the form of a physical medium. For example, an individual might travel to a local bookstore and purchase written works in the form of a book, newspaper, or magazine. In another example, an individual might purchase music stored on a Compact Disc (CD) or a motion picture stored on a Digital Video Disc (DVD). In recent years the ubiquity of the Internet and the World Wide Web has paved the way for alternative methods of obtaining and consuming content. For example, a user might log on to a music retailer's website and download a digital version of a music album. In other example, a user might log on to a movie subscription provider's website to download or stream a motion picture to view on a personal computer. In the case of books, a user might log on to a bookseller's website and download an electronic book (“e-book”) for view on a computer system, such as a desktop computer or a handheld e-book reader.

The Internet and World Wide Web serve as a backbone for numerous file sharing mechanisms. Examples of such mechanisms include electronic mail (“email”) and more advanced file distribution software, such as peer-to-peer (“P2P”) file sharing applications. In many cases, such file sharing mechanisms are often utilized to distribute electronic content to individuals that are not authorized to access such content. Such distribution is likely due in part to the relative ease and anonymity of sharing files through such mechanisms. To combat unauthorized consumption of content, some content owners have adopted an approach to protecting their content known as digital rights management (“DRM”), which may include various techniques for limiting access of electronic content to authorized individuals and/or enforcing other restrictions on the use of such content.

### SUMMARY

Various embodiments of a system and method for digital rights management with a lightweight digital watermarking component are described. Various embodiments may include computer-implemented methods as well as elements configured to perform such methods. In various embodiments, such a method may include receiving content onto a computer system; the computer system may include a runtime component configured to consume the content. An example of such content includes but is not limited to video content. The method may also include receiving a digital watermarking component via the computer system (e.g., received separate from the runtime component). The digital watermarking component may specify information for generating a digital watermark on the received content. Examples of such information include but are not limited to image or graphics data representing a digital watermark, instructions for applying a digital watermark, and/or executable logic for applying a digital watermark. The method may also include applying a digital watermark to the received content via the runtime component in order to generate watermarked content. In various embodiments, the digital watermark may be applied by the runtime component in accordance with the digital watermarking component. In various embodiments, the runtime component that is received may be configured to ensure that the received content cannot be consumed without the digital watermark applied to the received content.

Various embodiments may include elements or methods for providing the aforesaid digital watermarking component to a remote computer system. For instance, such a method may include providing such a digital watermarking component to a remote computer system, such as computer system that includes the aforesaid runtime component. In various embodiments, providing the digital watermarking component may include providing the digital watermarking component separate from the runtime component. In various embodiments, the digital watermarking component may specify information for applying a digital watermark on a portion of content. Various embodiments of such a method may also include providing to the remote computer system information that specifies that portion of content cannot be consumed without the digital watermark applied to that portion of content.

### BRIEF DESCRIPTION OF THE DRAWINGS

FIG. 1 illustrates a block diagram of the various elements of the system and method for digital rights management with a lightweight digital watermarking component, according to various embodiments.

FIG. 2A illustrates an example image prior to the application of a watermark, according to various embodiments.

FIG. 2B illustrates an example image subsequent to the application of a watermark, according to various embodiments.

FIG. 3 illustrates another example image subsequent to the application of a watermark, according to various embodiments.

FIG. 4 illustrates a one example of a system configuration for digital rights management with a lightweight digital watermarking component, according to various embodiments.

FIG. 5 illustrates a flowchart of an example method for receiving content and applying a watermark to such content with a digital watermarking component, according to various embodiments.

FIG. 6 illustrates a flowchart of an example method for provisioning digital watermarking components, according to various embodiments.

FIG. 7 illustrates an example computer system configured to implement various elements of the system and method for digital rights management with a lightweight digital watermarking component, according to various embodiments.

While the system and method for digital rights management with a lightweight digital watermarking component is described herein by way of example for several embodiments and illustrative drawings, those skilled in the art will recognize that the system and method for digital rights management with a lightweight digital watermarking component is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the system and method for digital rights management with a lightweight digital watermarking component as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. In various portions of the description presented herein, the terms “validate”, “verify”, “validation”, “verification”, “validating”, and “verifying” may be used interchangeably.

### DETAILED DESCRIPTION OF EMBODIMENTS

### Introduction

Various embodiments of a system and method for digital rights management with a lightweight digital watermarking component are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Various embodiments may include a distribution system configured to provide protected content (e.g., encrypted content) to one or more client systems. For example, a distribution system may serve web-based content, such as video content (or any other type of content described herein), to multiple client systems. In various embodiments, the distribution system may also provide a client with a digital watermarking component. Note that in various embodiments the distribution system that provides the watermarking component to a client may be but need not be the same distribution system that provides that client with the protected content. The watermarking component, when executed on the client system, may add a digital watermark to the content. An example of such a watermarking component includes but is not limited to a filter (e.g., executable logic or instructions) of the Adobe® Pixel Bender™ infrastructure.

A digital watermark may be a visible watermark or an invisible watermark. Visible watermarks may include graphics, text, images, icons, or other graphical elements that are superimposed onto frames of video content, individual photographs, or graphical content. In some cases, visible watermarks may be at least partially translucent so as to allow a partial view of the content “behind” the watermark. In various embodiments, visible watermarks may indicate a particular type of information, such as a name and/or an identifier. For instance, a visible watermark may indicate the name of an individual authorized to view the content to which the visible watermark is applied. Other types of visible watermarks are described in more detail herein. Visible watermarks may deter various types of unauthorized distribution. For example, if a video file is watermarked with the name of a customer that purchased the video file (or other information that identifies the customer or can be traced back to the customer), the customer may be less likely to share the video file with unauthorized users. For instance, the customer may be less likely to upload the video file to a website or a peer-to-peer file sharing network due to fear of having such file (and thus the unauthorized sharing of the file) traced back to him. Invisible watermarks may include any type of information embedded into content that is not human-perceptible absent some additional analysis performed by a computer system. While invisible watermarks may not be human-perceptible, computer-implemented logic may detect or retrieve an invisible watermark from watermarked content. Such logic is sometimes referred to as a watermark detection function or a watermark retrieval function. In some embodiments, applying a watermark may include applying both a visible watermark and an invisible watermark.

In various embodiments, the logic of the watermarking component sent to the client and/or the runtime component on the client system may ensure that the content cannot be accessed without a digital watermark applied to the content. In an example where the content is video content, the watermarking component and/or the runtime component may allow the video content to be played if and only if a watermark is superimposed on at least some of the frames of the video content. Other examples of ensuring that content cannot be accessed without a digital watermark applied to the content are described in more detail herein.

Various embodiments include various encryption and/or decryption keys, any of which may be generated via a key derivation function (KDF). Key derivation functions may include one or more iterations or instances of hash functions and/or other cryptographic operations in order to generate an encryption or decryption key. Examples of key derivation function may include but are not limited to any key derivation functions specified by Public Key Cryptography Standards (PKCS) (e.g., PKCS-5) or Adobe Password Security.

Various portions of this detailed description may refer to “client(s)” and “server(s)” or similar terminology. For instance, various embodiments may include (among other elements) a client system or client device (or simply a “client”). It should be understood that the terms “client” and “server” do not impose any limitation on the operation, configuration, or implementation of such elements. It should be understood that these terms are used only as convenient nomenclature. Indeed, various embodiments are in no way limited by the principles of a conventional client-server architecture. For instance, any of the “clients” or “servers” described herein may be configured to communicate according to a variety of communication protocols or system architectures, such as a peer-to-peer (P2P) architecture or some other architecture, whether such architecture is presently known or developed in the future.

In various instances, this detailed description may refer to content (which may also be referred to as “content item(s),” “content data,” “content information” or simply “data” or “information”). In general, content may include any information or data that may be licensed to one or more individuals (or other entities, such as business or group). In various embodiments, content may include electronic representations of video, audio, text and/or graphics, which may include but is not limited to electronic representations of videos, movies, or other multimedia, which may include but is not limited to data files adhering to Adobe® Flash® Video (.FLV or .F4V) format or some other video file format whether such format is presently known or developed in the future. In some cases, content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, Adobe® Photoshop® (.PSD) format or some other format for electronically storing text, graphics and/or other information whether such format is presently known or developed in the future. In some embodiments, content may include any combination of the above-described examples.

In various instances, this detailed disclosure may refer to consuming content or to the consumption of content, which may include accessing content, displaying content for view (e.g., for view by a user), playing content (e.g., in a media player), or rendering content (e.g., rendering 2D or 3D images) among other things. In some cases, the particular term utilized may be dependent on the context in which it is used. For example, consuming video may also be referred to as displaying or playing the video.

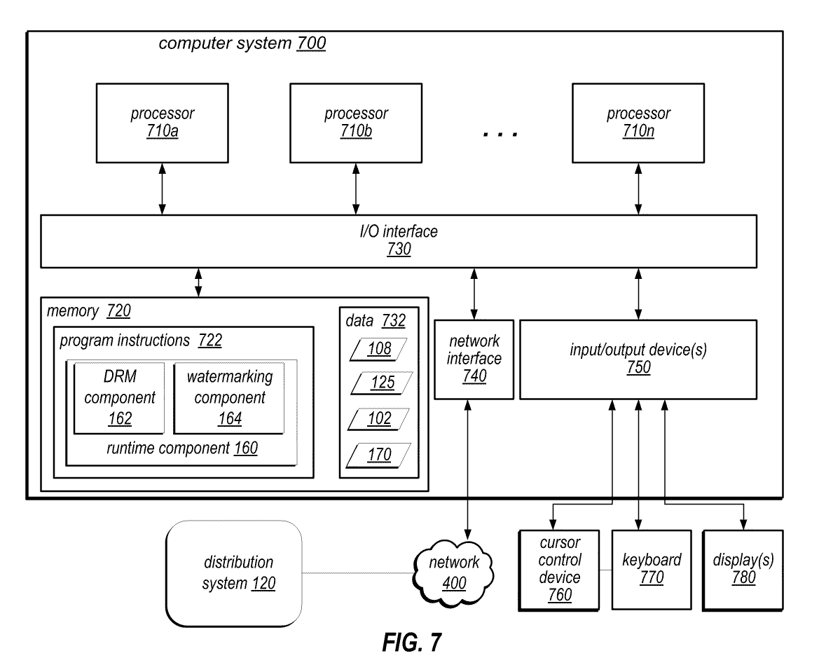

In various instances, this detailed description may refer to a device on which content may be consumed. In various embodiments, such a device may include but is not limited to a computing system (e.g., a desktop or laptop computer or other type of computer system), a digital audio or multimedia player (e.g., an MP3 player), a personal digital assistant (PDA), a mobile phone, a smartphone, an e-book reader, a digital photo frame, a television, a set top box (which may be used in conjunction with televisions or other monitors), a hand held or mobile device, or any other electronic device or system configured to access, view, read, write, and/or manipulate any of the content data described herein. Any of such devices may be implemented via a computer system similar to that described with respect to FIG. 7.

Note that in various instances the description presented herein may refer to a given entity performing some action. It should be understood that this language may in some cases mean that a system (e.g., a computer system) owned and/or controlled by the given entity is actually performing the action.

In various embodiments, various techniques may be utilized to provide secure communication between any of the elements of the DRM framework described herein. For instance, various elements of the DRM framework may be associated with respected public key - private key pairs, such as key pairs utilized in Public Key Infrastructure (PKI). In various embodiments, a first element (e.g., a content distribution system) may securely transfer data (e.g., a content license) to a second element by encrypting that data with the second element's public key. In this manner, only the second element will be able to decrypt the encrypted data to access the unencrypted data, according to various embodiments. For instance, since in various embodiments knowledge of a private key may be required to decrypt data and since the second element may be the only element that has knowledge of its own private key, the second element may be the only element able to decrypt the data with the correct private key. Note that the aforesaid techniques may in various embodiments be utilized for any transfer of data within the DRM framework described herein.

### Packaging

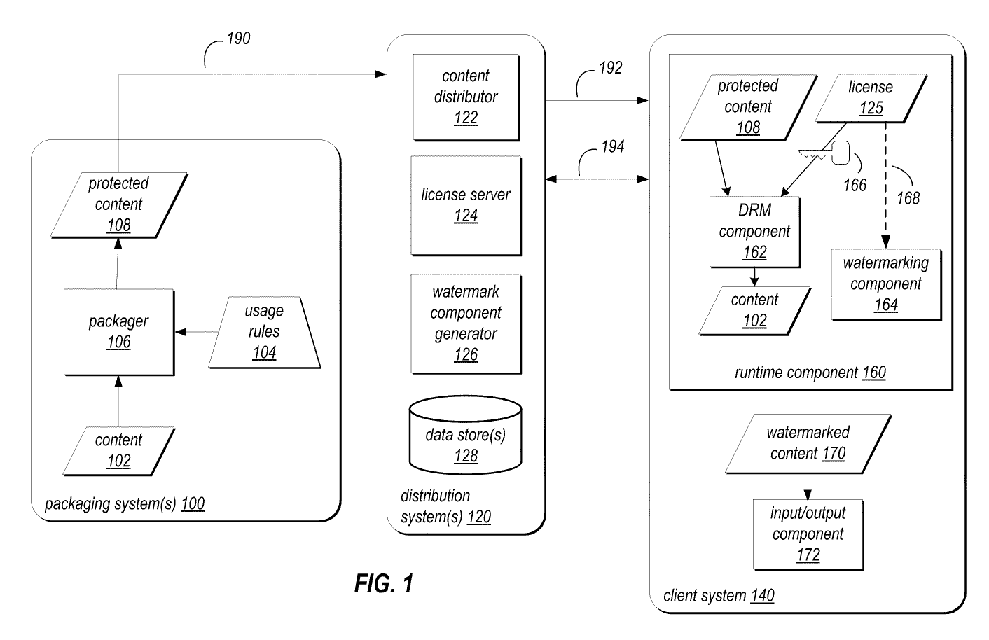

FIG. 1 illustrates various components of the system and method for digital rights management with a lightweight digital watermarking component. Packaging system(s) 100 may be implemented via one or more computer systems. In various embodiments, packaging system(s) 100 may be owned or controlled by a content owner or rights holder, an example of which includes an entity that owns rights to such content (e.g., copyrights or other intellectual property rights). In one particular example, a content owner may provide such content to other entities (e.g., content merchants or distributors) in exchange for licensing fees. For instance, such a content owner might produce content (e.g., a film) and license such content to a content merchant (e.g., an online merchant that sells or rents content online) that distributes the content to retail customers.

In various embodiments, packager 106 may be configured to package content 102 with usage rules 104 in order to generate protected content 108. Protecting or packaging content 102 may in some embodiments include encrypting the content with an encryption key. In some cases, this may also include encrypting usage rules 104 along with content 102 to generate protected content that includes such usage rules. In this case, if the protected content is eventually decrypted, the decrypted usage rules can be enforced on the usage of the content. In general, usage rules may include any restrictions on the use or access of the content including but not limited to restricting the access of content to a particular time period, restricting the actions (e.g., view, copy, save, distribute, etc.) that can be performed with respect to the protected content. In some cases, usage rules packaged together with content 102 may serve as a template to be populated with one or more rules by another entity (e.g., a content distributor that sells or rents the content). For instance, a content distributor may specify within such template a rule that indicates an expiration date for the content. As an alternative to storing usage rules within protected content (or in addition to storing usage rules within the protected content), usage rules may be stored within a content license for the content (described in more detail below). Storing the usage rules within the content license may facilitate creating user-specific usage rules for the same protected content; for instance, different licenses containing different usage rules can be created for different users.

### Distribution

In various embodiments, packaging system(s) 100 may provide different types of protected content, such as protected content 108, to one or more distribution system(s) 120, as illustrated by communication 190. In various embodiments, distribution system(s) 120 may request such content. In other cases, packaging system(s) 100 may automatically deliver such content to distribution system(s) 120 (e.g., in a “push” manner). The various instances of protected content received by distribution systems 120 may be stored within data store 128 such that the content is accessible to other elements of the distribution system. In various embodiments, data store 128 may be configured as a database, as one or more mass storage devices (e.g., physical disks, logical volumes, etc.) configured to store data blocks or files, or in any other suitable configuration for data storage. In various embodiments, data store 128 may store protected content 108 as well as multiple other portions of protected content.

Content distributor 122 may be configured to provide protected content to one or more clients, such as client 140. For instance, content distributor 122 may be a component of a web server (or other network-based server) that serves content to various clients. For example, a runtime component 160 may be part of a web browser or operate in conjunction with a web browser to issue a request for content from distribution system(s) 120. Distribution systems 120 may provide content to one or more clients, such as client 140, in response to such a request. In the illustrated embodiment, distribution system(s) 120 may provide protected content 108 (or other types of protected content) to client 140, as illustrated by communication 192. In various embodiments, runtime component may be a computer-implemented runtime environment in which various applications, programs, functions, scripts, bytecodes and/or other instructions may be executed. In one particular example, runtime component 100 may be Adobe® Flash® Player.

In various embodiments, as illustrated by communication(s) 194, runtime component 160 may issue a request for a content license for protected content 108. Such communication may also include runtime component 160 and license server 124 performing an authentication process in order to establish that client 140 (and/or a user of client 140) is authorized to receive a content license. In various embodiments, protected content cannot be consumed (e.g., presented, played, displayed, rendered, etc.) until a clear form of the content has been generated. For instance, if protected content 108 is encrypted (which may be the case), the protected content must be decrypted in order to access the unencrypted version of the content (e.g., content 102). In various embodiments, the aforesaid content license may include a content key that may be utilized to decrypt protected content 108. In other words, protected content 108 may not be consumed without obtaining the appropriate license for that content in various embodiments. As such, license server 124 may only provide a content license for protected content 108 to authorized clients (or authorized users operating such client machines).

Various types of information may be exchanged during communication(s) 194 in order to carry out the authentication process. In some embodiments, runtime component 160 may provide a username and password associated with a customer account and/or a content purchase. License server 124 may verify such information by comparing it to information (e.g., customer records, customer profiles, purchase records, etc.) within data store(s) 120. In some cases, runtime component 160 may provide a digital credential (e.g., a digital certificate issued by a trusted third party) as part of the authentication process, one example of which includes an X.509 digital certificate. In other cases, other types of digital credentials may be sent from the runtime component 160 to license server 124, time-based codes, biometric information, or other verifiable information to establish the identity of client system 140 (or a user controlling such system). In various embodiments, information identifying runtime component 160 (e.g., a version or instance identifier), client system 140 (e.g., a machine address or internet protocol address), or other elements of client system 140 may be provided to license server 124 during communication(s) 194.

If the license server 124 does not positively verify the information provided by the client system, the license server may withhold the content license that corresponds to protected content 108 from the client system. If the license server 124 does positively verify (e.g., by comparing the information provided to information on record in data store 128), the license server may send content license 125 (which may include the correct content key for decrypting protected content 108) to runtime component 160. In some cases, a content license may also be referred to as a content policy.

License 125 may include the content key for decrypting protected content 108 (which may in many cases, but not necessarily all cases, be specific to that content). License 125 may also include one or more usage rules (which may also be referred to as policy rules). In general, usage rules may include any restrictions on the use or access of the content including but not limited to restricting the access of content to a particular time period, restricting the actions (e.g., view, copy, save, distribute, etc.) that can be performed with respect to the protected content. In various embodiments, usage rules may specify whether a watermark is to be applied to protected content 108 prior to consumption of that content. In the illustrated embodiment, license 125 may specify that protected content 108 may only be consumed with a watermark applied to that content. In various embodiments, license 125 may specify the particular watermarking component (described in more detail below) that is to be utilized to apply such a watermark.

In various embodiments, distribution system 120 may also provide a watermarking component 164 to runtime component 160. In various embodiments, this watermarking component is not present on client system 140 prior to receiving such watermarking component from the distribution system. In some cases, such as in the illustrated embodiment, the watermarking component 164 may be delivered to runtime component 160 as part of content license 125 (e.g., watermarking component 164 is included within content license 125). Runtime component 160 may be configured to extract runtime component 164 from content license 125 in various embodiments, as illustrated at 168. In embodiments, where the watermarking component 164 is an element of the content license 125, the authentication process described with respect to 194 may serve as an authentication process for the content license as well as the watermarking component 164 (by virtue of the watermark components inclusion within the license). In embodiments where the watermarking component 164 is an element distinct from the content license, either the authentication process described with respect to communications 194 or a separate similar authentication process may be utilized to control access to the watermarking component.

In various embodiments, the watermarking component(s) provided by distribution system(s) 120 to client system 140 may be generated by watermark component generator 126. For instance, in embodiments where license server inserts a watermarking component into license 125, the license server may query watermark component generator 126 for data representing such watermark component. In various embodiments, such data may include executable instructions (which may be represented by bytecode) configured to apply a watermark to a portion of content. Watermark component generator 126 may be configured to provide the license server with watermark components for inclusion within a content license and delivery to a client system. In embodiments where the watermarking component(s) provided by distribution system(s) 120 are provided to client systems separately from content licenses, the watermark component generator 126 may provide such watermarking component(s) to such client systems.

As described above, the watermarking component described herein may in some embodiments include executable instructions, such as bytecode. Runtime component 160 may in various embodiments execute such instructions to apply a watermark to content. In some embodiments, runtime component may implement a virtual machine configured to execute the watermarking component. For instance, in embodiments where the watermarking component is represented by executable bytecode, the runtime component described herein may be configured to utilize the aforesaid virtual machine to execute the bytecode. In one example, the runtime component described herein may implement a virtual machine adhering to the Adobe® Pixel Bender™ infrastructure and the watermarking component may be a filter adhering to the Adobe® Pixel Bender™ infrastructure; such a filter may be represented by bytecode that may be executed by the aforesaid virtual machine in order to apply a watermark to content.

### Decryption and Watermarking

In various embodiments, runtime component 160 may include a digital rights management (DRM) component 162. One particular example of DRM component 162 includes Adobe® DRM Client for Flash® Player. In various embodiments, DRM component 162 may be configured to extract a content key 166 from license 125 and decrypt protected content 108 with such key. In the illustrated embodiment, the result of such decryption is illustrated as content 102, which may be the same as the content 102 originally packaged at packaging system(s) 100. In various embodiments, DRM component 162 may be configured to perform encryption/decryption according to various techniques including but not limited to symmetric encryption/decryption and asymmetric encryption/decryption.

In various embodiments, content 102 may be the clear (e.g., not-encrypted) form of protected content 108. To protect such content from being compromised, content 102 may be protected by a tamper-resistant (or tamper-proof) environment provided by runtime component 160. Content 102 may in various embodiments only be accessible or “visible” to runtime component 160 and elements of such runtime component. In this way, other components of client system 140 outside of the domain of runtime component 160 may be prohibited from accessing content 102. The tamper-resistant environment of the runtime component may be implemented by the runtime component via a variety of techniques including but not limited to representing only portions (e.g., small packets in some cases) of sensitive data within memory at any given instant in time. For instance, data may be processed portion by portion as a stream whereby only a portion of the stream is visible in memory at one time. In some cases, the tamper-resistant environment may perform an obfuscation process on data or executable instructions (or code) of any element or data accessible to the runtime component. In various embodiments, runtime component 160 may be configured to detect the presence of debuggers (e.g., debugging applications, scripts, elements, etc.) and prevent access to content 102 in response to such detection. Other security techniques to prevent access to content 102 may be implemented in various embodiments, whether such techniques are presently known or developed in the future.

As described above, watermarking component 164 may be received from distribution system(s) 120 (e.g., received within a content license or separate from the content license). Note that in various instances, watermarking component 164 may not be present on client system 140 prior to receiving such component from a distribution system 120. In various embodiments, runtime component 160 may be configured to apply a watermark to content 102 (as specified by the watermarking component) prior to such content becoming accessible to components outside of the tamper-resistant environment of runtime component 160.

In various instances, applying a digital watermark to content is largely described as being performed by runtime component 160. Also note that the manner in which the runtime component applies the watermark may be specified by watermarking component 164. For instance, watermarking component may be a data file that specifies the type of watermark or information to be displayed and the runtime component may be configured to apply a watermark to the content based on such information. In some embodiments, watermarking component may include executable instructions and the runtime component may be configured to apply a watermark by executing such instructions. It should be understood that the application of the watermark may in some cases be performed by the watermarking component itself. For instance, in some embodiments, watermarking component 160 may be a software module that is configured to apply a watermark and the runtime component may initiate the execution of such module in order to apply a watermark to the content. While applying a digital watermark to content is largely described as being performed by runtime component 160 herein, any of the above-described implementations may be utilized in various embodiments.

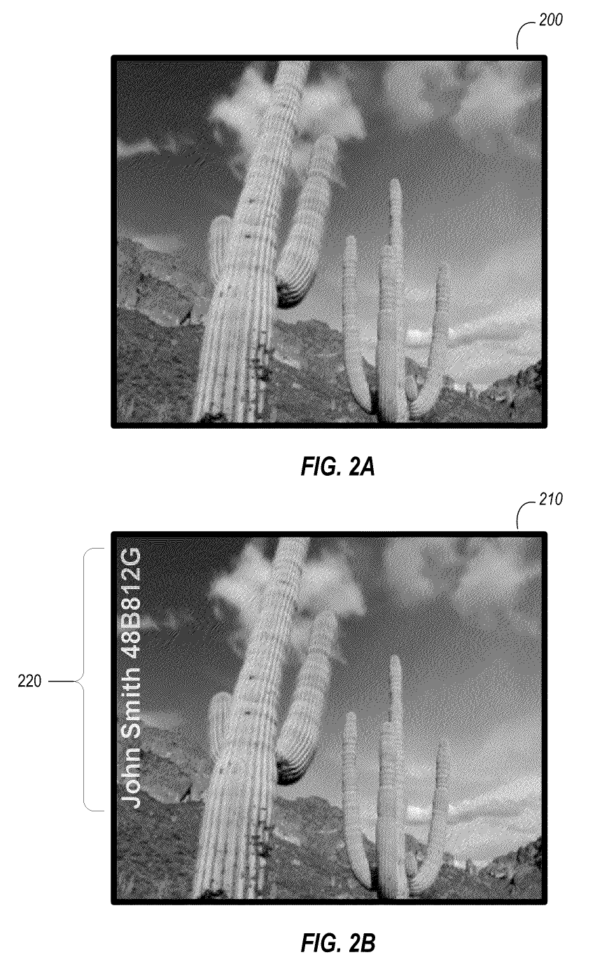

In various embodiments, runtime component 160 may apply a watermark according to different techniques. For instance, applying a watermark may include superimposing or otherwise inserting information (e.g., graphical elements, text, etc.) into content 102 to generate a new version of such content (illustrated as watermarked content 170, described below). In some cases, the majority of the generated watermarked content 170 may be the same as the content 102 from which the watermarked content 170 is generated. In various embodiments, the difference between content 102 and watermarked content 170 may be the watermark itself. For instance, image 200 of FIG. 2A may be a video frame (e.g., a single image of all the images that make up a video) that represents one example of content 102. Image 210 of FIG. 2B is an example of the same video frame after having a watermark graphic 220 applied to the frame. In various embodiments, such a process of applying a watermark to a video frame or image may be implemented by watermarking component 164 described herein.

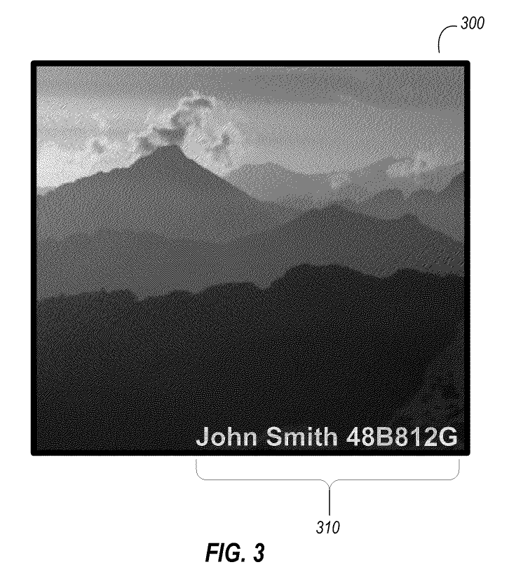

In various embodiments, the position and/or orientation of a watermark may vary over the playback period of video content (e.g., the watermark may be applied differently to different frames of the same video). In one example, image 210 may be a frame of video content and image 300 of FIG. 3 may be another frame of the same video content. Note that the position and orientation of watermark 220 and watermark 310 are not the same. In various embodiments, watermarking component 164 may vary the position and/or orientation of a watermark in video content in order to defend against a malicious user cropping out a portion of the content (e.g., the bottom 100 pixels of an image, or some other portion) in order to remove a watermark from watermarked content.

In various embodiments, runtime component 160 may access information about client system 140 (and/or information about a user of client system 140) and generate watermarked content 170 such that the watermark displayed as part of the content indicates such information. For instance, runtime component 160 may generate watermarked content 170 such that the watermark indicates various identifying information including one or more of: a machine identifier of client system 140 (e.g., host address, internet protocol address, Media Access Control address, or some other identifier of the client system), a user identifier that identifies a user of the client system and/or a user authorized to consume the content (e.g., a name, a code, an identifier issued by a third party, a username, a customer identifier, etc.), a software identifier that identifies one or more applications (e.g., the runtime component) installed on the client system, information identifying a publisher that published the received content, or some other type of identifier. As described above, the presence of a watermark in watermarked content 170 may deter various types of unauthorized distribution. For example, if a video file is watermarked with the name of a customer that purchased the video file, the customer may be less likely to share the video file with unauthorized users.

In various embodiments, the identifying information (e.g., the various identifiers described above) included within the watermark of watermarked content 170 may be initially retrieved by runtime component 160 (as specified by watermarking component 164) prior to generating the watermark. For instance, runtime component 160 may be configured to search for or locate identifying information from client system 140, such as any of the identifiers described above. For instance, runtime component 160 may be configured to locate a machine identifier on client system 140 and include such identifier in the watermark of watermarked content 170. In another example, runtime component 160 may be configured to locate a user identifier (e.g., a name or username) on client system 140 and include such identifier in the watermark of watermarked content 170. In some cases, runtime component 160 may be configured to receive identifying information from distribution system(s) 120 and include such identifier in the watermark of watermarked content 170. In any of the above-described techniques, the actual process of applying the watermark to the content to generate watermarked content 170 may occur at client system 140. For instance, protected content 108 received at the client system and content 102 generated from the protected content (e.g., via decryption) may not include the watermark that is applied by runtime component 160. In various embodiments, only after the runtime component applies a watermark in accordance with watermarking component 164 does the content include the particular watermark generated by the watermarking component.

In some embodiments, the information (e.g., the various identifiers described above) included within the watermark of watermarked content 170 may be received by runtime component 160 from distribution system(s) 120. For instance, distribution system(s) 120 may provide such information within license 125 or some other data provided to runtime component 160. In one example, license 125 and/or watermarking component 164 may include data representing a watermark graphic; such graphic may be applied by runtime component 160 to content 102 in order to generate watermarked content 170. In other cases (e.g., the embodiments described above), the actual watermark graphic applied to content 102 may be generated from information retrieved by runtime component 160 on the client system (e.g., the watermark graphic may not exist on the client system prior to executing watermark component 164).

In various embodiments, watermarked content 170 may be provided to an input/output (“IO”) component 172. In various embodiments, IO component 172 may be configured to output a graphical representation of watermarked content 170, such as on a display (e.g., display 780 described below with respect to FIG. 7).

In various embodiments, the watermarking that is performed to generate watermarked content 170 from content 102 may be an irreversible process. For example, in some cases, it may not be possible to regenerate content 102 given only watermarked content 170.

### Watermark Enforcement

In various embodiments, runtime component 160 may be configured to enforce a requirement that content cannot be consumed prior to determining that watermarking component 164 is present on and/or executing on client system 140. In some embodiments, protected content 108 and/or license 125 may specify the particular watermarking component to be utilized to apply a watermark to such content. For instance, the license may specify the particular watermark component to be utilized by the inclusion of an identifier that identifies the particular watermark component. In embodiments where the watermarking component is included within the content license, the particular watermarking component to be utilized may be specified by virtue of such inclusion (e.g., the runtime component may extract the watermarking component from the license and use that watermarking component to apply a watermark to content).

In various embodiments, runtime component 160 may be configured to determine whether the specified watermarking component is present on client system 140. If the specified watermarking component is present on the client system, the runtime component may apply a particular watermark to the content in order to generate watermarked content 170 in accordance with information specified by the watermarking component 164. If the watermarking component is not present on the client system, the runtime component may prohibit access to content 102. For instance, in various embodiments, multiple other watermarking components similar to watermarking component 164 may be installed on the client system (e.g., watermarking components from other distribution systems). In such cases, runtime component 160 may be configured to deny such watermarking components access to the particular content 102 (unless such watermarking components are specified by protected content 108 and/or license 125 as being authorized watermarking components).

In various embodiments, in addition to (or as an alternative to) the above-described enforcement techniques, possession of watermarking component 164 may be required for decrypting a portion of protected content 108 to regenerate content 102. For instance, packaging system(s) 100 and/or distribution systems 120 may encrypt one or more portions of content 102 or protected content 108 with a second content key. The particular key to decrypt such portions may be held by watermarking component 164 in various embodiments. In this way, without the proper watermarking component that is assigned to the particular portion of content (e.g., protected content 108, content 102), runtime component 160 may not fully decrypt such content. Accordingly, even were an attacker to break the decryption scheme performed by DRM component 162, the attacker would not be able to decrypt the portions of protected content 108 that must be decrypted with the decryption key specified by watermarking component 164.

### Revocation and Updating of Watermarking Components

In some cases, an attacker may attempt to compromise watermarking component 164 in order to bypass the application of a watermark to content that is output from the runtime component. For instance, an attacker may attempt to spoof watermarking component 164 with an unauthorized component that presents itself to runtime component 160 as a legitimate runtime component 160; such unauthorized component may attempt to have content output without the correct watermark applied to the content. Techniques for overcoming the aforesaid threat are described below.

In various embodiments (as described above), the content on the client system may require that a watermark be applied to the content prior to runtime component 160 providing access to the content (e.g., access to watermarked content 170). In some cases, to overcome an attack where watermarking component 164 is compromised, runtime component 160 and/or distribution system 120 may be configured to revoke the watermarking component and replace it with a new watermarking component (e.g., a watermarking component known to be uncompromised).

Distribution system 120 may in various embodiments maintain a list or record of revoked or untrusted watermarking components. For instance, each watermarking component of various embodiments may be identified by a unique identifier and distribution system(s) 120 may store a list of identifiers identifying revoked or untrusted watermark components. Runtime component 160 (or any component thereof) may be configured to access such list or record to determine whether a particular watermarking component installed on and/or executing via runtime component 160 is listed as a revoked or untrusted watermarking component. If watermarking component 164 is determined to be untrusted or revoked, the runtime component may invalidate the use of that watermarking component.

In cases where watermarking component 164 is determined to be untrusted or revoked, runtime component 140 may be configured to receive a new watermark component from distribution system(s) 120. The new watermark component may be known to be trusted or authorized watermarking component. Note that the aforesaid process of receiving a new watermarking component enables the client system to be updated with a new watermarking component without updating runtime component 160. In some cases, the data footprint of the watermarking component may be smaller than that of the runtime component 160. By enabling the client system to be updated with a new watermarking component without updating runtime component 16, various embodiments may provide a lightweight approach to updating the watermarking component (e.g., to overcome a security breach in the watermarking scheme). In some embodiments, such as embodiments that utilize a watermarking component represented by bytecode that may be executed by the runtime component, updating the watermarking according to the techniques described herein may bypass some security requirements on the client system being updated. For instance, in some cases, the client system may be updated without querying a user of the system for permission to install or run the watermarking component; such techniques may bolster the usability of the system as well as provide a more positive end-user experience.

### Example System Configuration

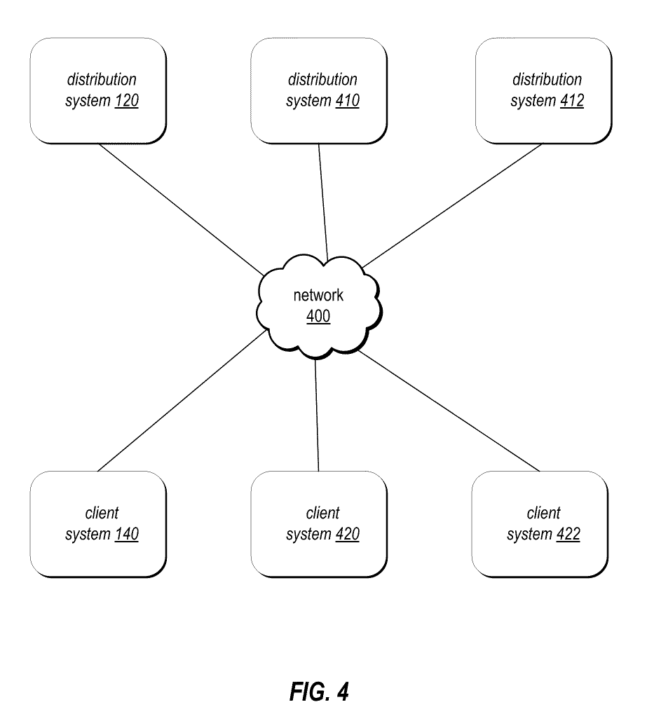

FIG. 4 illustrates one example system configuration, which may be utilized in various embodiments. In the illustrated embodiment, multiple computer systems (e.g., distribution system 120, distribution systems 410-412, clients 140 and 420-422) may be coupled to a network 400. In the illustrated embodiment, each system may be configured to communicate to any other system via network 400. Network 400 may be a variety of one or more networks including but not limited to Local Area Networks (LANs), Wide Area Networks (WANs), telecommunication networks (e.g., mobile voice and data networks), some other type of network, or some combination thereof. In the illustrated embodiment, any of the illustrated distribution systems may be configured as described above with respect to distribution system(s) 120. Likewise, any of the illustrated client systems may be configured as client system 140 described above.

In various embodiments, any given one of the illustrated distribution systems may be configured to provide a watermarking component (as described above) to any or all of the illustrated client systems. In some cases, the watermarking component provided by one distribution system may be different than the watermarking component of another distribution system. For instance, in various embodiments, the types of watermark generated by watermarking components of distribution systems may be different. In another example, watermarks generated by watermarking components of distribution systems may specify different information. For instance, one might specify user information whereas another might specify machine information. In various embodiments, each distribution system may provide a custom watermarking component tailored to the needs of the entity controlling that distribution system. In this way, embodiments may utilize diversity among the various watermarking components to bolster the security of the overall DRM framework described herein. For instance, even were one watermarking component to be compromised by an attacker, the aforesaid diversity would limit such security breach to that particular watermarking component.

To further bolster the security of the watermarking components, various embodiments may utilize watermarking components that have been obfuscated, such as by modifying the data that represents such components with an obfuscation tool. In various embodiments, such an obfuscation tool may be configured to obfuscate data, bytecode, and/or machine code (or other executable instructions). In one example, any of the watermarking components and/or cryptographic keys described herein may be obfuscated prior to using such elements in the above-described implementations. Obfuscating the aforesaid items may enhance the overall security of various embodiments by, e.g., concealing the purpose of executable code in order to deter reverse engineering. In various embodiments, the security techniques described herein may cause different portions of data (e.g., encryption keys) to be distributed across multiple memory buffers (e.g., only a portion of such data may be available in memory at any given time) such that a memory inspection or debugging session will not result in a security compromise of those portions of data.

In various embodiments, any given one of the illustrated client systems may be configured to receive multiple watermarking components (as described above) from any or all of the illustrated distribution systems. For instance, a given client system may receive content from different content distributors. Each content distributor may have a different requirement regarding the application of watermarks to the content that they distribute. For instance, as described above, one distributor might specify that user information be part of the watermark whereas another might specify machine information be part of the watermark. Accordingly, any given one of the client systems illustrated may be configured to receive multiple portions of content and apply, for each portion of content, the correct watermark that portion of content according to techniques similar to those described with respect to FIG. 1.

### Example Methods

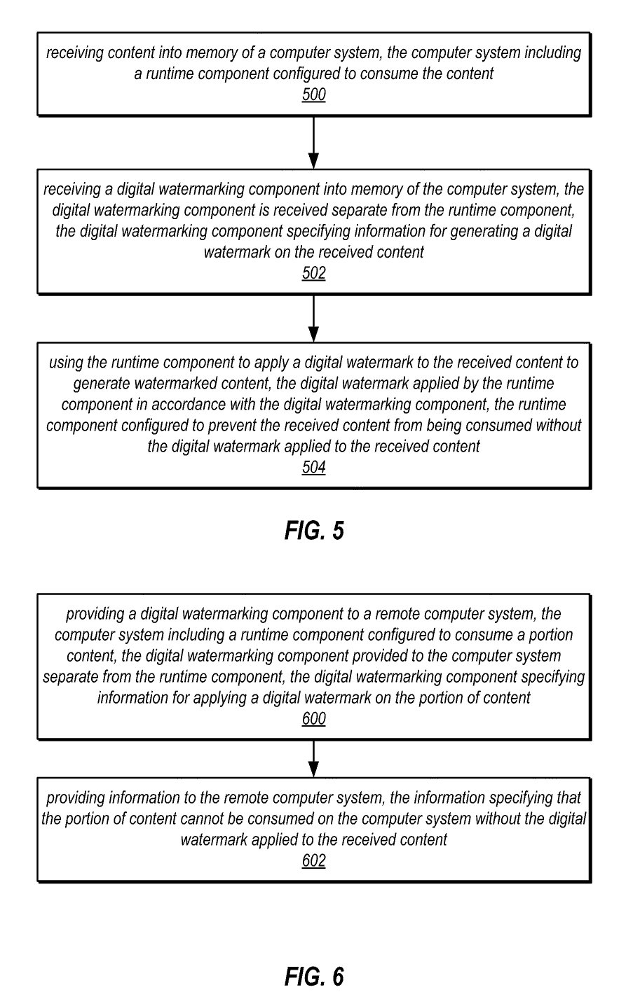

The system and method for digital rights management with a lightweight digital watermarking component may include various methods, some of which are described below with respect to FIGS. 5 and 6. In various embodiments, the methods illustrated may be performed by the computer system of FIG. 7 described below.

FIG. 5 illustrates a flowchart for receiving content and applying a watermark to such content with a digital watermarking component. In some embodiments, the illustrated method may be implemented via a runtime component, such as runtime component 160 described above. As illustrated by block 500, the method may include receiving content on a computer system (e.g., receiving content into one or more memories of the computer system); such computer system may include a runtime component configured to consume the content. For instance, one example of receiving content may include receiving content similar to protected content 108 described above. The runtime component may include any example of a runtime component described herein (e.g., Adobe® Flash® Player or any other runtime component described herein). Furthermore, consuming content in this context may include any technique for consuming content as described above (e.g., played, viewed, displayed, etc.). One example illustrating the receipt of content is described above with respect to communication 192.

As illustrated by block 502, the method may also include receiving a digital watermarking component on the computer system (e.g., receiving a digital watermarking component into one or more memories of the computer system). Such digital watermarking component may be received separately from the runtime component described above. For instance, the computer system may include the runtime component prior to the receipt of the digital watermarking component. Furthermore, the digital watermarking component may specify information for generating a digital watermark on the received content.

The information for generating a digital watermark on the received content may be different in various embodiments. In one embodiment, the information might include an image or graphic that constitutes the actual watermark to be applied to the content. In some embodiments, the information might include any of the identifying information described above with respect to watermarked content 170 (e.g., machine identifiers, user identifiers, publisher identifiers, etc.); the runtime component may be configured to apply a watermark (to the content) that includes such identifying information. In some embodiments, the information might include executable instructions (e.g., bytecode or other instructions) that may be implemented by the runtime component to apply a digital watermark to content. In some embodiments, the information might include data representing a software module that may be executed to apply a digital watermark to content.

As illustrated by block 504, the method may also include using the runtime component to apply a digital watermark to the received content to generate watermarked content. In various embodiments, the digital watermark may be applied by the runtime component in accordance with the digital watermarking component. In various embodiments, the runtime component may also be configured to prevent the received content from being consumed without the digital watermark applied to the received content. For instance, in an example where the content is video content, the watermarking component and/or the runtime component may allow the video content to be played if and only if a watermark is superimposed on at least some of the frames of the video content. Other examples of ensuring that content cannot be accessed without a digital watermark applied to the content are described above.

In various embodiments, applying a digital watermark to the received content via the runtime component may include accessing information (e.g., identifying information including but not limited to a machine identifier, software identifier, publisher identifier, or user identifier and inserting such information into the received content. In some cases, this may be performed such that the information is visible (such as the visible watermarks described above); in other cases, this may be performed such that the information is not human-perceptible (such as the invisible watermarks described above). In some cases, the method may include inserting both visible and invisible versions of the watermark within the content.

In embodiments where the digital watermarking component comprises executable instructions for applying a watermark, the method may include utilizing the runtime component to execute such instructions to apply the watermark to the content. In embodiments where the digital watermarking component is a software module configured to apply a digital watermark to content, the method may include executing the digital watermarking component to apply the watermark to the content.

In various embodiments, the particular runtime component utilized to apply the watermark may be configured to ensure that the received content cannot be consumed without the digital watermark applied to the received content. For instance, the runtime component utilized by the method may be configured to employ any of the techniques described above with respect to watermark enforcement. Examples of watermarked content that may be generated according to the above-described method include the images of FIG. 2B and FIG. 3 (although other types of watermarks are possible and contemplated).

FIG. 6 illustrates a flowchart for provisioning digital watermarking components in various embodiments. In some embodiments, the illustrated method may be implemented via a distribution system, such as distribution system(s) 120 described above. As illustrated by block 600, the method may include providing a digital watermarking component to a remote computer system; the computer system may include a runtime component configured to consume a portion content. Additionally, the digital watermarking component may be provided to the computer system separate from the runtime component. For instance, in some cases, the runtime component may already be installed on the remote computer system when the watermarking component is provided to that computer system. In various embodiments, the digital watermarking component may specify information for applying a digital watermark on the portion of content (which may be similar to the information described above with respect to FIG. 5).

As illustrated by block 602, the method may include providing information to the remote computer system; such information may specify that the portion of content cannot be consumed on the computer system without the digital watermark applied to the received content. In some embodiments, providing such information may include providing a content license that specifies the content cannot be consumed on the computer system without the digital watermark applied to the received content. In some cases, the content license may specify such information as a usage rules for the content. In various embodiments, such information may be provided to a client system, such as client system 140 described above or any other computer system configured to enforce such a usage rule (e.g., enforce the application of the watermark to the content).

Note that the methods that are possible and contemplated under the scope of the system and method for digital rights management with a lightweight digital watermarking component are not limited to the examples described above. In some cases, elements may be added or removed from the methods while remaining within the spirit and scope of the system and method for digital rights management with a lightweight digital watermarking component. In various embodiments, any of the functionality described above with respect to the components of FIG. 1 may be implemented as elements of a computer-implemented method, such as the methods of FIGS. 5 and 6.

### Example Computer System

Various embodiments of a system and method for digital rights management with a lightweight digital watermarking component, as described herein, may be executed on one or more computer systems, which may interact with various other devices. One such computer system is computer system 700 illustrated by FIG. 7, which may in various embodiments implement any of the elements illustrated in FIGS. 1-6. Computer system 700 may be capable of implementing the functionality of a client system or a distribution system (such as those described above with respect to FIG. 1) which may be stored in memory as processor-executable program instructions. In the illustrated embodiment, computer system 700 includes one or more processors 710 coupled to a system memory 720 via an input/output (I/O) interface 730. Computer system 700 further includes a network interface 740 coupled to I/O interface 730, and one or more input/output devices 750, such as cursor control device 760, keyboard 770, and display(s) 780. In some embodiments, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. While not presented according to the level of detail as computer system 700 (which may implement the functionality of client system 140 in some embodiments), the functionality of distribution system 120 may also be implemented via a computer system, such as computer system 700.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs), such as the x66, PowerPC, SPARC, or MIPS ISAs, or any other suitable ISA. In multiprocessor systems, each of processors 710 may commonly, but not necessarily, implement the same ISA.

System memory 720 may be configured to store program instructions 722 and/or data 732 accessible by processor 710. In various embodiments, data 732 may include any of the data described above including but not limited to protected content 108, content license 125, content 102, and watermarked content 170. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the DRM framework (as described above), may be stored within system memory 720. For instance, program instructions 722 may be executable to implement DRM component 162 and watermarking component 164. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 400), such as other computer systems (e.g., distribution system 120), or between nodes of computer system 700. In various embodiments, network interface 740 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or accessing data by one or more computer systems 600. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the methods described above, such as the method illustrated by FIGS. 5-6. In other embodiments, different elements and data may be included. In various embodiments, the illustrated computer system may be configured to generate images and/or video, such as the images of FIGS. 2B and 3 (including the watermarks on such images).

Those skilled in the art will appreciate that computer system 700 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the embodiments described herein may be practiced with other computer system configurations.

Various embodiments may further include receiving, sending or storing instructions and/or data implemented in accordance with the foregoing description upon a computer-accessible medium. Generally speaking, a computer-accessible medium may include a storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of methods may be changed, and various elements may be added, reordered, combined, omitted, modified, etc. Various modifications and changes may be made as would be obvious to a person skilled in the art having the benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A computer-implemented method, comprising:
receiving content into memory of a computer system, the computer system including a runtime component configured to consume the content;
receiving a digital watermarking component into memory of the computer system, wherein the digital watermarking component is received separate from said runtime component, wherein the digital watermarking component specifies information for generating a digital watermark on the received content; and
using the runtime component to apply a digital watermark to the received content to generate watermarked content, wherein the digital watermark is applied by the runtime component in accordance with said digital watermarking component;
wherein the runtime component is configured to prevent the received content from being consumed without the digital watermark applied to the received content.

2. The computer-implemented method of claim 1, further comprising:
in response to determining that said digital watermarking component has been revoked, replacing the digital watermarking component on said computer system with a second digital watermarking component that specifies information for applying a digital watermark to the received content.

3. The computer-implemented method of claim 2, wherein replacing the digital watermarking component is performed without replacing the runtime component.

4. The computer-implemented method of claim 1, wherein the digital watermark applied to the received content indicates one or more of: information identifying a user authorized to consume the protected content, information identifying said computer system, information identifying a publisher that published the received content, or information identifying said runtime component.

5. The computer-implemented method of claim 1, wherein said received content is video content, wherein the digital watermark is applied such that the digital watermark is superimposed on one or more frames of said video content.

6. The computer-implemented method of claim 1, further comprising, prior to generating the watermarked content, decrypting at least a portion of the received content with a content key from the digital watermarking component.

7. The computer-implemented method of claim 1, wherein receiving the digital watermarking component comprises receiving a content license for the received content, the content license comprising the digital watermarking component.

8. The computer-implemented method of claim 1, wherein the watermarking component comprises executable instructions for applying said digital watermark, wherein applying said digital watermark comprises executing the instructions of the watermarking component.

9. The computer-implemented method of claim 8, wherein the runtime component is configured to implement a virtual machine, wherein at least some of said executable instructions are represented in bytecode, wherein applying said digital watermark comprises executing the bytecode on said virtual machine.

10. A computer-implemented method, comprising:
providing a digital watermarking component to a remote computer system, the remote computer system including a runtime component configured to consume a portion of content, the digital watermarking component provided to said remote computer system separate from the runtime component, the digital watermarking component specifying information for applying a digital watermark on the portion of content; and
providing information to said remote computer system, the information specifying that said portion of content cannot be consumed on the remote computer system without the digital watermark applied to the received content.

11. The computer-implemented method of claim 10, wherein the method comprises:
revoking the digital watermarking component without revoking the runtime component;
subsequent to said revoking, providing the remote computer system with a second digital watermarking component distinct from said runtime component, the second digital watermarking component specifying information for applying a digital watermark on the portion of content.

12. The computer-implemented method of claim 11, wherein revoking the digital watermarking component comprises creating a record corresponding to that digital watermarking component in a list of revoked watermarking components, said list accessible to the particular computer system.

13. The computer-implemented method of claim 10, wherein the digital watermark indicates one or more of: information identifying a user authorized to consume the protected content, information identifying said computer system, information identifying a publisher that published said protected content, or information identifying said runtime component.

14. The computer-implemented method of claim 10, wherein providing the computer system with a digital watermarking component comprises providing the remote computer system with a content license for said portion of content, the content license comprising the digital watermarking component.

15. The computer-implemented method of claim 10, wherein providing the remote computer system with information specifying that said portion of content cannot be consumed on the remote computer system without the digital watermark applied to the received content comprises:
providing the remote computer system with a content license for said portion of content, the content license comprising the information specifying that said portion of content cannot be consumed on the remote computer system without the digital watermark applied to the received content.

16. A system, comprising:
a memory; and
one or more processors coupled to the memory, wherein the memory comprises program instructions executable by the one or more processors to:
receive content;
provide a runtime component configured to consume the content;
receive a digital watermarking component, wherein the digital watermarking component is received separate from said runtime component, wherein the digital watermarking component specifies information for generating a digital watermark on the received content; and
wherein the runtime component is configured to apply a digital watermark to the received content to generate watermarked content, wherein the runtime component is configured to apply the digital watermark in accordance with said digital watermarking component, wherein the runtime component is configured to prevent the received content from being consumed without the digital watermark applied to the received content.

17. The system of claim 16, wherein the program instructions are configured to:
in response to determining that said digital watermarking component has been revoked, replace the digital watermarking component of the system with a second digital watermarking component that specifies information for applying a digital watermark to the received content.

18. The system of claim 17, wherein the program instructions are configured to replace the digital watermarking component without replacing the runtime component.

19. The system of claim 16, wherein the digital watermark applied to the received content indicates one or more of: information identifying a user authorized to consume the protected content, information identifying said computer system, information identifying a publisher that published the received content, or information identifying said runtime component.

20. The system of claim 16, wherein said received content is video content, wherein the digital watermark is applied such that the digital watermark is superimposed on one or more frames of said video content.

21. The system of claim 16, wherein the program instructions are configured to, prior to generating the watermarked content, decrypt at least a portion of the received content with a content key from the digital watermarking component.

22. The system of claim 16, wherein to receive the digital watermarking component the program instructions are configured to receive a content license for the received content, the content license comprising the digital watermarking component.

23. The system of claim 16, wherein the watermarking component comprises executable instructions for applying said digital watermark, wherein to apply said digital watermark the runtime component is configured to execute the instructions of the watermarking component.

24. The system of claim 23, wherein the runtime component is configured to implement a virtual machine, wherein at least some of said executable instructions are represented in bytecode, wherein to apply said digital watermark the runtime component is configured to execute the bytecode on said virtual machine.

25. A system, comprising:
a memory; and
one or more processors coupled to the memory, wherein the memory comprises program instructions executable by the one or more processors to:
provide a digital watermarking component to a remote computer system, the remote computer system including a runtime component configured to consume a portion of content, the digital watermarking component provided to said remote computer system separate from the runtime component, the digital watermarking component specifying information for applying a digital watermark on the portion of content; and
provide information to said remote computer system, the information specifying that said portion of content cannot be consumed on the remote computer system without the digital watermark applied to the received content.

26. The system of claim 25, wherein the program instructions are configured to:
revoke the digital watermarking component without revoking the runtime component;
subsequent to that revocation, provide the remote computer system with a second digital watermarking component distinct from said runtime component, the second digital watermarking component specifying information for applying a digital watermark on the portion of content.

27. The system of claim 26, wherein to revoke the digital watermarking component the program instructions are configured to create a record corresponding to that digital watermarking component in a list of revoked watermarking components, said list accessible to the particular computer system.

28. The system of claim 25, wherein the digital watermark indicates one or more of: information identifying a user authorized to consume the protected content, information identifying said computer system, information identifying a publisher that published said protected content, or information identifying said runtime component.

29. The system of claim 25, wherein to provide the computer system with a digital watermarking component the program instructions are configured to provide the remote computer system with a content license for said portion of content, the content license comprising the digital watermarking component.

30. The system of claim 25, wherein to provide the remote computer system with information specifying that said portion of content cannot be consumed on the remote computer system without the digital watermark applied to the received content, the program instructions are configured to:
provide the remote computer system with a content license for said portion of content, the content license comprising the information specifying that said portion of content cannot be consumed on the remote computer system without the digital watermark applied to the received content.

31. A computer-readable storage medium, storing program instructions computer-executable on a computer system to:
receive content;
provide a runtime component configured to consume the content;
receive a digital watermarking component, wherein the digital watermarking component is received separate from said runtime component, wherein the digital watermarking component specifies information for generating a digital watermark on the received content; and
wherein the runtime component is configured to apply a digital watermark to the received content to generate watermarked content, wherein the runtime component is configured to apply the digital watermark in accordance with said digital watermarking component, wherein the runtime component is configured to prevent the received content from being consumed without the digital watermark applied to the received content.

32. The medium of claim 31, wherein the program instructions are configured to:
in response to determining that said digital watermarking component has been revoked, replace the digital watermarking component of the system with a second digital watermarking component that specifies information for applying a digital watermark to the received content.

33. The medium of claim 32, wherein the program instructions are configured to replace the digital watermarking component without replacing the runtime component.

34. The medium of claim 31, wherein the digital watermark applied to the received content indicates one or more of: information identifying a user authorized to consume the protected content, information identifying said computer system, information identifying a publisher that published the received content, or information identifying said runtime component.

35. The medium of claim 31, wherein said received content is video content, wherein the digital watermark is applied such that the digital watermark is superimposed on one or more frames of said video content.

36. The medium of claim 31, wherein the program instructions are configured to, prior to generating the watermarked content, decrypt at least a portion of the received content with a content key from the digital watermarking component.

37. The medium of claim 31, wherein to receive the digital watermarking component the program instructions are configured to receive a content license for the received content, the content license comprising the digital watermarking component.

38. The medium of claim 31, wherein the watermarking component comprises executable instructions for applying said digital watermark, wherein to apply said digital watermark the runtime component is configured to execute the instructions of the watermarking component.

39. The medium of claim 38, wherein the runtime component is configured to implement a virtual machine, wherein at least some of said executable instructions are represented in bytecode, wherein to apply said digital watermark the runtime component is configured to execute the bytecode on said virtual machine.

40. A computer-readable storage medium, storing program instructions computer-executable on a computer system to:
provide a digital watermarking component to a remote computer system, the remote computer system including a runtime component configured to consume a portion of content, the digital watermarking component provided to said remote computer system separate from the runtime component, the digital watermarking component specifying information for applying a digital watermark on the portion of content; and
provide information to said remote computer system, the information specifying that said portion of content cannot be consumed on the remote computer system without the digital watermark applied to the received content.

41. The medium of claim 40, wherein the program instructions are configured to:
revoke the digital watermarking component without revoking the runtime component;
subsequent to that revocation, provide the remote computer system with a second digital watermarking component distinct from said runtime component, the second digital watermarking component specifying information for applying a digital watermark on the portion of content.

42. The medium of claim 41, wherein to revoke the digital watermarking component the program instructions are configured to create a record corresponding to that digital watermarking component in a list of revoked watermarking components, said list accessible to the particular computer system.

43. The medium of claim 40, wherein the digital watermark indicates one or more of: information identifying a user authorized to consume the protected content, information identifying said computer system, information identifying a publisher that published said protected content, or information identifying said runtime component.

44. The medium of claim 40, wherein to provide the computer system with a digital watermarking component the program instructions are configured to provide the remote computer system with a content license for said portion of content, the content license comprising the digital watermarking component.

45. The medium of claim 40, wherein to provide the remote computer system with information specifying that said portion of content cannot be consumed on the remote computer system without the digital watermark applied to the received content, the program instructions are configured to:
provide the remote computer system with a content license for said portion of content, the content license comprising the information specifying that said portion of content cannot be consumed on the remote computer system without the digital watermark applied to the received content.
